(19) United States
(12) Patent Application Publication
(10) Pub. No.: US 2024/0381163 A1
(43) Pub. Date: Nov. 14, 2024

(54) METHOD AND APPARATUS FOR WIRELESS COMMUNICATION

(71) Applicant: Lenovo (Beijing) Limited, Beijing (CN)

(72) Inventors: Yibin Zhuo, Beijing (CN); Mingzeng Dai, Shanghai (CN); Lianhai Wu, Beijing (CN); Le Yan, Shanghai (CN)

(73) Assignee: Lenovo (Beijing) Limited, Beijing (CN)

(21) Appl. No.: 18/577,833

(22) PCT Filed: Jul. 9, 2021
(86) PCT No.: PCT/CN2021/105548

§ 371 Date: Jan. 9, 2024

(51) Int. Cl. H04W 28/02; H04W 40/34; H04W 88/08

(52) U.S. Cl. CPC H04W 28/0263; H04W 28/0278; H04W 40/34; H04W 88/085

(57) ABSTRACT

Embodiments of the present disclosure relate to wireless communication in an IAB network. According to some embodiments of the disclosure, a method performed by an IAB node may include: receiving flow control feedback; and performing bearer remapping based on the received flow control feedback.

### TECHNICAL FIELD

Embodiments of the present disclosure generally relate to wireless communication technology, and more particularly to wireless communication in an integrated access and backhaul (IAB) network.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

To extend the coverage and availability of wireless communication systems (e.g., 5G systems), the 3rd generation partnership project (3GPP) is envisioning integrated access and backhaul (IAB) architecture for supporting multi-hop relays. In an IAB network, an IAB node may hop through one or more IAB nodes before reaching a base station (also referred to as “an IAB donor” or “a donor node”). A single hop may be considered a special instance of multiple hops. Multi-hop backhauling is beneficial because it provides a relatively greater coverage extension compared to single-hop backhauling. In a relatively high frequency radio communication system (e.g., radio signals transmitted in frequency bands over 6 GHz), relatively narrow or less signal coverage may benefit from multi-hop backhauling techniques.

The industry desires technologies for handling wireless communications in the IAB network.

### SUMMARY

Some embodiments of the present disclosure provide a method performed by an integrated access and backhaul (IAB) node. The method may include: receiving flow control feedback; and performing bearer remapping based on the received flow control feedback.

In some embodiments of the present disclosure, performing bearer remapping based on the received flow control feedback may include: selecting an available egress backhaul (BH) radio link control (RLC) channel (CH) based on the received flow control feedback and a threshold for available buffer size. The threshold for available buffer size may be configured by an IAB donor connected to the IAB node, is configured by a centralized unit (CU) of the IAB donor, or is predefined. The threshold for available buffer size may be configured or predefined per BH RLC CH or per IAB node.

In some embodiments of the present disclosure, the method may further include: determining an egress BH RLC CH as available in response to the egress BH RLC CH being not indicated in the received flow control feedback; or determining an egress BH RLC CH as available in response to the received flow control feedback indicating the egress BH RLC CH being available.

In some embodiments of the present disclosure, the method may further include: receiving a backhaul adaptation protocol (BAP) data packet data unit (PDU) to be transmitted by the IAB node. Performing bearer remapping based on the received flow control feedback may include: comparing an ingress backhaul (BH) link, an ingress BH radio link control (RLC) channel (CH) and an egress BH link of the BAP data PDU to an entry of a BH RLC CH mapping configuration to determine a matched entry; and determining whether an egress BH RLC CH associated with the matched entry is available or not based on the received flow control feedback.

In some embodiments of the present disclosure, the method may further include: in response to determining that the egress BH RLC CH associated with the matched entry is available, selecting the egress BH RLC CH associated with the matched entry for transmitting the BAP data PDU.

In some embodiments of the present disclosure, the method may further include: in response to determining that the egress BH RLC CH associated with the matched entry is unavailable, selecting an available egress BH RLC CH, a default BH RLC CH, or a backup BH RLC CH on the egress BH link of the BAP data PDU for transmitting the BAP data PDU. One or more of the default BH RLC CH and the backup BH RLC CH may be configured by an IAB donor connected to the IAB node or a centralized unit (CU) of the IAB donor.

Some embodiments of the present disclosure provide a method performed by an integrated access and backhaul (IAB) node. The method may include: determining a failure of a buffer status reporting (BSR) associated with a parent node of the IAB node; and performing rerouting based on the failure of the BSR, in order to reroute data from the parent node of the IAB node.

In some embodiments of the present disclosure, the method may further include: transmitting or triggering the BSR to the parent node of the IAB node; and starting a timer in response to the transmission or triggering of the BSR; wherein determining the failure of the BSR may include determining the failure of the BSR in response to the expiry of the timer. A value of the timer may be configured by an IAB donor connected to the IAB node, is configured by a centralized unit (CU) of the IAB donor, or is predefined.

In some embodiments of the present disclosure, the method may further include: receiving a backhaul adaptation protocol (BAP) data packet data unit (PDU) to be transmitted by the IAB node. Performing the rerouting based on the failure of the BSR may include: comparing BAP routing ID of the BAP data PDU to an entry of a BH routing configuration to determine a matched entry; in response to an egress backhaul (BH) link associated with the matched entry being unavailable, selecting an available egress BH link associated with an entry of the BH routing configuration based on the failure of the BSR; and transmitting the BAP data PDU on the selected available egress BH link.

Some embodiments of the present disclosure provide a method performed by an integrated access and backhaul (IAB) node. The method may include: receiving flow control feedback from a first IAB node; and performing rerouting based on the received flow control feedback, in order to reroute data from the first IAB node to a second IAB node.

Performing the rerouting based on the received flow control feedback may include: selecting an available egress backhaul (BH) link based on a backhaul adaptation protocol (BAP) routing ID indicated in the received flow control feedback. In some embodiments of the present disclosure, the method may further include: determining an egress BH link associated with the BAP routing ID as unavailable.

Performing the rerouting based on the received flow control feedback may include: selecting an available egress backhaul (BH) link based on a backhaul adaptation protocol (BAP) routing ID indicated in the received flow control feedback and a threshold for available buffer size. In some embodiments of the present disclosure, the method may further include at least one of: determining an egress BH link associated with the BAP routing ID as unavailable in response to an available buffer size associated with the BAP routing ID is less than or equal to the threshold for available buffer size; and determining an egress BH link associated with the BAP routing ID as available in response to an available buffer size associated with the BAP routing ID is greater than the threshold for available buffer size. The threshold for available buffer size may be configured by an IAB donor connected to the IAB node, may be configured by a centralized unit (CU) of the IAB donor, or may be predefined. The threshold for available buffer size may be configured or predefined per BAP routing ID or per IAB node.

In some embodiments of the present disclosure, the method may further include: determining an egress backhaul (BH) link as available in response to a backhaul adaptation protocol (BAP) routing ID with which the egress BH link is associated being not indicated in the received flow control feedback; or determining an egress BH link as available in response to the received flow control feedback indicating a BAP routing ID with which the egress BH link is associated being available.

In some embodiments of the present disclosure, the method may further include: receiving an indication, from an IAB donor connected to the IAB node or a parent IAB node of the IAB node, indicating whether rerouting based on flow control feedback is allowed or not at the IAB node.

In some embodiments of the present disclosure, the method may further include: transmitting, to an IAB donor connected to the IAB node or a parent IAB node of the IAB node, a capability of whether rerouting based on flow control feedback is supported or not at the IAB node.

In some embodiments of the present disclosure, the method may further include: receiving a backhaul adaptation protocol (BAP) data packet data unit (PDU) to be transmitted by the IAB node. Performing the rerouting based on the received flow control feedback may include: determining at least one available entry of a backhaul (BH) routing configuration based on the received flow control feedback; in response to a match between BAP routing ID of the BAP data PDU and a first available entry of the at least one available entry, selecting an available egress BH link associated with the first available entry; in response to no match between the BAP routing ID of the BAP data PDU and the at least one the available entry, selecting an available egress BH link associated with a second available entry of the at least one available entry; and transmitting the BAP data PDU on the selected available egress BH link.

Some embodiments of the present disclosure provide a method performed by an integrated access and backhaul (IAB) node. The method may include: receiving a radio link failure (RLF) indication from a first IAB node, wherein the first IAB node is either a parent node or a child node of the IAB node; and performing rerouting based on the received RLF indication, in order to reroute data from the first IAB node to a second IAB node.

In some embodiments of the present disclosure, the received RLF indication may indicate an RLF detection or a backhaul (BH) recovery. Performing the rerouting based on the received RLF indication may include: determining an egress BH link between the IAB node and the first IAB node as unavailable; and selecting an available egress BH link of the IAB node for data transmission.

In some embodiments of the present disclosure, the received RLF indication may indicate a recovery success. Performing the rerouting based on the received RLF indication may include: determining an egress BH link between the IAB node and the first IAB node as available; and selecting an available egress BH link of the IAB node for data transmission.

In some embodiments of the present disclosure, the method may further include: receiving an indication, from an IAB donor connected to the IAB node or a parent IAB node of the IAB node, indicating whether rerouting based on an RLF indication is allowed or not at the IAB node. In some embodiments of the present disclosure, the method may further include: transmitting, to an IAB donor connected to the IAB node or a parent IAB node of the IAB node, a capability of whether an RLF indication is supported or not at the IAB node, a capability of whether rerouting based on the RLF indication is supported or not at the IAB node, or both. The RLF indication may indicate an RLF detection, a backhaul (BH) recovery, or a recovery success.

In some embodiments of the present disclosure, the method may further include: receiving a backhaul adaptation protocol (BAP) data packet data unit (PDU) to be transmitted by the IAB node. Performing the rerouting based on the received RLF indication may include: comparing BAP routing ID of the BAP data PDU to an entry of a backhaul (BH) routing configuration to determine a matched entry; in response to an egress BH link associated with the matched entry being unavailable, selecting an available egress BH link associated with an entry of the BH routing configuration based on the received RLF indication; and transmitting the BAP data PDU on the selected available egress BH link.

Some embodiments of the present disclosure provide an integrated access and backhaul (IAB) node. The IAB node may include a transceiver configured to receive flow control feedback from a first IAB node; and a processor coupled to the transceiver, wherein the processor is configured to perform rerouting from the first IAB node to a second IAB node, based on the received flow control feedback.

Some embodiments of the present disclosure provide an integrated access and backhaul (IAB) node. The IAB node may include a transceiver configured to receive a radio link failure (RLF) indication from a first IAB node, wherein the first IAB node is either a parent node or a child node of the IAB node; and a processor coupled to the transceiver, wherein the processor is configured to perform rerouting from the first IAB node to a second IAB node, based on the received RLF indication.

Some embodiments of the present disclosure provide an integrated access and backhaul (IAB) node. According to some embodiments of the present disclosure, the IAB node may include: a transceiver; and a processor coupled to the transceiver, wherein the transceiver and the processor may interact with each other so as to perform a method according to some embodiments of the present disclosure.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate the deployment of the IAB node and can facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an example block diagram of a protocol stack for an IAB network in accordance with some embodiments of the present disclosure;

FIG. 3 illustrates an example block diagram of a protocol stack for an IAB network in accordance with some embodiments of the present disclosure;

FIG. 4 illustrates an exemplary BAP PDU format for flow control feedback in accordance with some embodiments of the present disclosure;

FIG. 5 illustrates an exemplary BAP PDU format for flow control feedback in accordance with some embodiments of the present disclosure;

FIG. 6 illustrates a flow chart of an exemplary procedure of wireless communications in accordance with some embodiments of the present disclosure;

FIG. 7 illustrates a flow chart of an exemplary procedure of wireless communications in accordance with some embodiments of the present disclosure;

FIG. 8 illustrates a flow chart of an exemplary procedure of wireless communications in accordance with some embodiments of the present disclosure;

FIG. 9 illustrates a flow chart of an exemplary procedure of wireless communications in accordance with some embodiments of the present disclosure; and

FIG. 10 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

Compared with the 4G communication system, the 5G communication system has raised more stringent requirements for various network performance indicators, for example, 1000-times capacity increase, wider coverage requirements, ultra-high reliability, ultra-low latency, etc. Considering the rich frequency resources of high-frequency carriers, the use of high-frequency small station deployments is becoming more and more popular in hotspot areas in order to meet the needs of 5G ultra-high capacity. However, high-frequency carriers have poor propagation characteristics, severe attenuation due to obstructions, and limited coverage. Therefore, the dense deployment of small stations is required. On the other hand, the deployment of optical fiber is difficult and costly for these small stations. Therefore, an economical and convenient backhaul scheme is needed. Integrated Access and Backhaul (IAB) technology, whose access link and backhaul link both use wireless transmission solutions to avoid fiber deployment, provides ideas for solving the above problems.

In an IAB network, a relay node (RN) or an IAB node or a wireless backhaul node/device can provide wireless access services for UEs. That is, a UE can connect to an IAB donor relayed by one or more IAB nodes. And the IAB donor may also be called a donor node or a donor base station (e.g., DgNB, Donor gNodeB). In addition, the wireless link between an IAB donor and an IAB node, or the wireless link between different IAB nodes can be referred to as a “backhaul link.”

An IAB node may include an IAB mobile terminal (MT) part and an IAB distributed unit (DU) part. When an IAB node connects to its parent node (which may be another IAB node or an IAB donor), it can be regarded as a UE, i.e., the role of the MT. When an IAB node provides service to its child node (which may be another IAB node or a UE), it can be regarded as a network device, i.e., the role of the DU.

An IAB donor can be an access network element with a complete base station function, or an access network element with a separate form of a centralized unit (CU) and a distributed unit (DU). The IAB donor may be connected to the core network (for example, connected to the 5G core network (5GC)), and provide the wireless backhaul function for the IAB nodes. The CU of an IAB donor may be referred to as an “IAB donor-CU” (or directly referred to as a “CU”), and the DU of the IAB donor may be referred to as an “IAB donor-DU.” The IAB donor-CU may be separated into a control plane (CP) and a user plane (UP). For example, a CU may include one CU-CP and one or more CU-UPs.

Considering the small coverage of a high frequency band, in order to ensure the coverage performance of the network, multi-hop networking may be adopted in an IAB network. Taking into account the requirements of service transmission reliability, IAB nodes can support dual connectivity (DC) or multi-connectivity to improve the reliability of transmission, so as to deal with abnormal situations that may occur on the backhaul (BH) link, such as radio link failure (RLF) or blockage, load fluctuations, etc.

In the case where an IAB network supports multi-hop and dual-connection networking, there may be multiple transmission paths between the UE and the IAB donor. A transmission path may include multiple nodes, such as a UE, one or more IAB nodes, and an IAB donor (if the IAB donor is in the form of a separate CU and DU, it may also contain an IAB donor-DU and an IAB donor-CU). Each IAB node may treat the neighboring node that provides backhaul services for it as a parent node (or parent IAB node), and each IAB node can be regarded as a child node (or child IAB node) of its parent node.

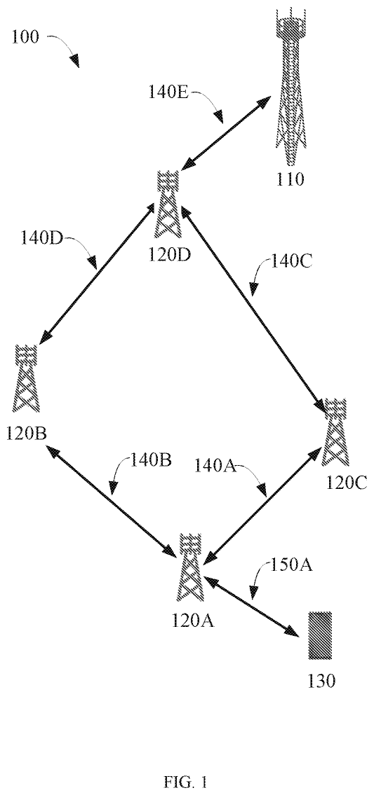

FIG. 1 illustrates a schematic diagram of a wireless communication system 100 in accordance with some embodiments of the present disclosure.

As shown in FIG. 1, the wireless communication system 100 may include a base station (e.g., IAB donor 110), some IAB nodes (e.g., IAB node 120A, IAB node 120B, IAB node 120C, and IAB node 120D), and a UE (e.g., UE 130). Although a specific number of UEs. IAB nodes, and IAB donors are depicted in FIG. 1, it is contemplated that any number of UEs, IAB nodes, and IAB donors may be included in the wireless communication system 100.

Each of IAB donor 110, IAB node 120A, IAB node 120B, IAB node 120C and IAB node 120D may be directly connected to one or more IAB node(s) in accordance with some other embodiments of the present disclosure. Each of IAB donor 110, IAB node 120A, IAB node 120B, IAB node 120C and IAB node 120D may be directly connected to one or more UEs in accordance with some other embodiments of the present disclosure.

UE 130 may be any type of device configured to operate and/or communicate in a wireless environment. For example, UE 130 may include a computing device, such as a desktop computer, a laptop computer, a personal digital assistant (PDA), a tablet computer, a smart television (e.g., television connected to the Internet), a set-top box, a game console, a security system (including a security camera), a vehicle on-board computer, a network device (e.g., router, switch, and modem), or the like. According to some embodiments of the present disclosure, UE 130 may include a portable wireless communication device, a smart phone, a cellular telephone, a flip phone, a device having a subscriber identity module, a personal computer, a selective call receiver, or any other device that is capable of transmitting and receiving communication signals on a wireless network. In some embodiments of the present disclosure, UE 130 may include wearable devices, such as smart watches, fitness bands, optical head-mounted displays, internet-of-things (IoT) devices, or the like. Moreover, UE 130 may be referred to as a subscriber unit, a mobile, a mobile station, a user, a terminal, a mobile terminal, a wireless terminal, a fixed terminal, a subscriber station, a user terminal, or a device, or described using other terminology used in the art.

IAB donor 110 may be in communication with a core network (not shown in FIG. 1). The core network (CN) may include a plurality of core network components, such as a mobility management entity (MME) (not shown in FIG. 1) or an access and mobility management function (AMF) (not shown in FIG. 1). The CNs may serve as gateways for the UEs to access a public switched telephone network (PSTN) and/or other networks (not shown in FIG. 1).

Wireless communication system 100 may be compatible with any type of network that is capable of transmitting and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, IAB donor 110 may transmit data using an orthogonal frequency division multiple (OFDM) modulation scheme on the DL. UE 130 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

Persons skilled in the art should understand that as technology develops and advances, the terminologies described in the present disclosure may change, but should not affect or limit the principles and spirit of the present disclosure.

Referring to FIG. 1, IAB node 120D can be directly connected to IAB donor 110. IAB donor 110 is a parent node of IAB node 120D. In other words, IAB node 120D is a child IAB node of IAB donor 110. IAB nodes 120B and 120C can reach IAB donor 110 by hopping through IAB node 120D. IAB node 120D is a parent IAB node of IAB nodes 120B and 120C. In other words, IAB nodes 120B and 120C are child IAB nodes of IAB node 120D.

IAB node 120A can be connected to IAB node 120B so it can reach IAB donor 110 by hopping through IAB node 120B and IAB node 120D. IAB node 120A and IAB node 120B may be referred to as the downstream (or descendant) IAB nodes of IAB node 120D. IAB node 120B and IAB node 120D may be referred to as the upstream IAB nodes of IAB node 120A. IAB node 120A can also be connected to IAB node 120C so it can reach IAB donor 110 by hopping through IAB node 120C and IAB node 120D.

UE 130 can be connected to IAB node 120A. Uplink (UL) packets (e.g., data or signaling) from UE 130 can be transmitted to an IAB donor (e.g., IAB donor 110) via one or more IAB nodes, and then transmitted by the IAB donor to a mobile gateway device (such as the user plane function (UPF) in 5GC). Downlink (DL) packets (e.g., data or signaling) can be transmitted from the IAB donor (e.g., IAB donor 110) after being received by the gateway device, and then transmitted to UE 130 through one or more IAB nodes. For example, referring to FIG. 1, UE 130 may transmit UL data to IAB donor 110 or receive DL data therefrom via IAB node 120A.

In an IAB deployment such as the wireless communication system 100, the radio link between an IAB donor (e.g., IAB donor 110 in FIG. 1) and an IAB node or between two IAB nodes may be referred to as a backhaul link (BL). The radio link between an IAB donor (e.g., IAB donor 110 in FIG. 1) and a UE or between an IAB node and a UE may be referred to as an access link (AL). For example, in FIG. 1. radio links 140A to 140E are BLs and radio link 150 is an AL.

An egress BH link may refer to a BH link on which a packet is transmitted by a node (e.g., an IAB node or IAB donor). An ingress BH link may refer to a BH link on which a packet is received by a node (e.g., an IAB node or IAB donor). An egress BH RLC channel may refer to a BH RLC channel on which a packet is transmitted by a node (e.g., an IAB node or IAB donor). An ingress BH RLC channel may refer to a BH RLC channel on which a packet is received by a node (e.g., an IAB node or IAB donor). For example, from the perspective of IAB node 120B, an egress BH RLC channel may refer to a BH RLC channel between 120B and 120D or a BH RLC channel between IAB nodes 120B and 120A. For instance, for UL, an egress BH RLC channel of IAB node 120B may refer to a BH RLC channel between IAB nodes 120B and 120D; and for DL, an egress BH RLC channel of IAB node 120B may refer to a BH RLC channel between IAB nodes 120B and 120A.

A protocol layer, the backhaul adaptation protocol (BAP) layer, located above the radio link control (RLC) layer is introduced in an IAB system, and can be used to realize packet routing, bearer mapping and flow control on the wireless backhaul link.

An F1 interface may be established between an IAB node (e.g., the DU part of the IAB node) and an IAB donor (e.g., IAB donor-CU). The F1 interface may support both a user plane protocol (e.g., F1-U) and a control plane protocol (e.g., F1-C). The user plane protocol of the F1 interface may include one or more of a general packet radio service (GPRS) tunneling protocol user plane (GTP-U), user datagram protocol (UDP), internet protocol (IP) and other protocols. The control plane protocol of the F1 interface may include one or more of an F1 application protocol (F1AP), stream control transport protocol (SCTP), IP, and other protocols.

Through the control plane of the F1 interface, an IAB node and an IAB donor can perform, for example, interface management, IAB-DU management, and UE context-related configuration. Through the user plane of the F1 interface, an IAB node and an IAB donor can perform, for example, user plane data transmission and downlink transmission status feedback functions.

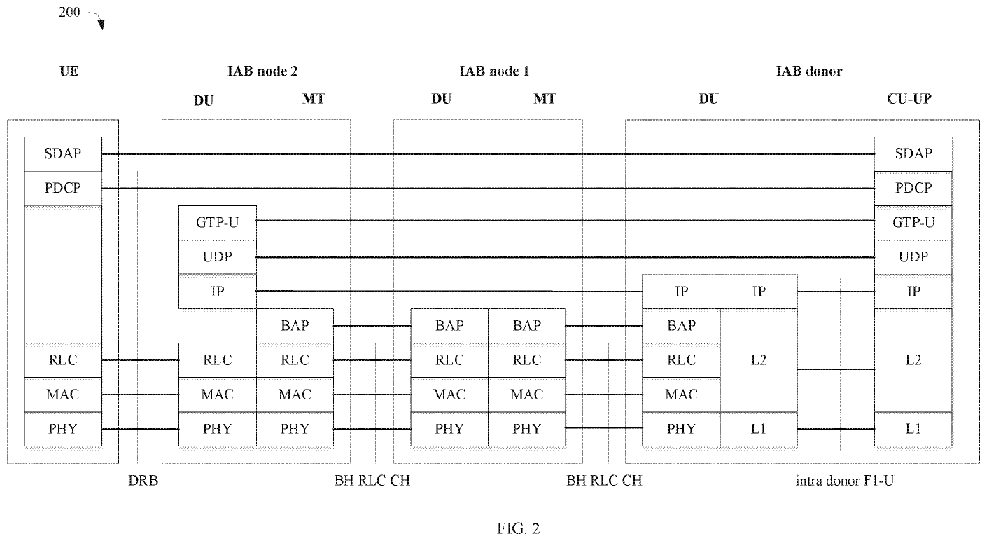

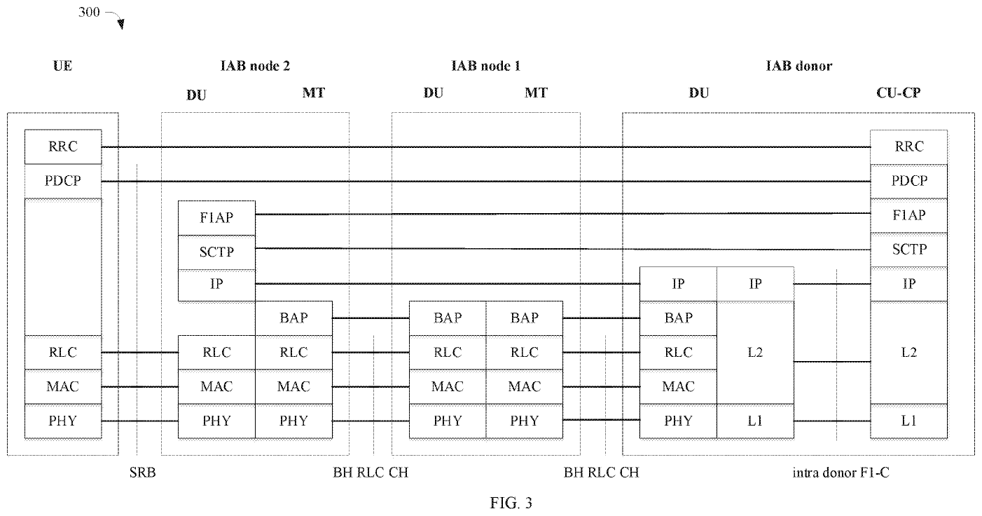

FIG. 2 illustrates an example block diagram of a user plane (UP) protocol stack 200 for an IAB network according to some embodiments of the present disclosure. FIG. 3 illustrates an example block diagram of a control plane (CP) protocol stack 300 for an IAB network according to some embodiments of the present disclosure. In FIGS. 2 and 3, a UE may be connected to an IAB donor via IAB node 2 and IAB node 1.

Referring to FIG. 2, the UP protocol stack of the UE may include a service data adaptation protocol (SDAP) layer, a packet data convergence protocol (PDCP) layer, a radio link control (RLC) layer, a medium access control (MAC) layer, and a physical (PHY) layer. The UP protocol stack of the DU of IAB node 2 may include a GTP-U layer, a UDP layer, an IP layer, an RLC layer, a MAC layer, and a PHY layer. The UP protocol stack of the MT of IAB node 2 or the DU or MT of IAB node 1 may include a BAP layer, an RLC layer, a MAC layer, and a PHY layer. The UP protocol stack of the DU of the IAB donor may include an IP layer, a BAP layer, an RLC layer, a MAC layer, and a PHY layer, where the PHY layer belongs to layer 1 (L1), and the BAP layer, the RLC layer, and the MAC layer belong to layer 2 (L2). The protocol stack of the CU-UP of the IAB donor may include a GTP-U layer, a UDP layer, an IP layer, a SDAP layer, a PDCP layer, an L2 layer(s), and an L1 layer.

Referring to FIG. 3, the CP protocol stack of the UE may include a radio resource control (RRC) layer, a PDCP layer, an RLC layer, a MAC) layer, and a physical (PHY) layer. The CP protocol stack of the DU of IAB node 2 may include an F1AP layer, an SCTP layer, an IP layer, an RLC layer, a MAC layer, and a PHY layer. The CP protocol stack of the MT of IAB node 2 or the DU or MT of IAB node 1 may include a BAP layer, an RLC layer, a MAC layer, and a PHY layer. The CP protocol stack of the DU of the IAB donor may include an IP layer, a BAP layer, an RLC layer, a MAC layer, and a PHY layer, where the PHY layer belongs to L1, and the BAP layer, the RLC layer, and the MAC layer belong to L2. The protocol stack of the CU-CP of the IAB donor may include an RRC layer, a PDCP layer, an F1AP layer, an SCTP layer, an IP layer, an L2 layer(s), and an L1 layer.

The protocol stacks shown in FIGS. 2 and 3 are only for illustrative purpose. For example, the sequences of some of the protocol layers in the protocol stacks of FIGS. 2 and 3 may be rearranged for illustrative purpose. For example, although the SDAP and PDCP layers belong to L2, they are shown above the GTP-U layer, the UDP layer and the IP layer in the protocol stack of the CU-UP of the IAB donor in FIG. 2.

In some embodiments of the present disclosure, flow control, including DL flow control and UL flow control, is supported on the BAP layer. For example, for DL flow control, an IAB node can send feedback information on the available buffer size for an ingress BH RLC channel or BAP routing ID to its parent node(s). In some examples, the feedback may be sent proactively, for instance, when the buffer load exceeds a certain threshold, or based on polling by the parent node. For UL flow control, an IAB node can send similar feedback information to its child node(s).

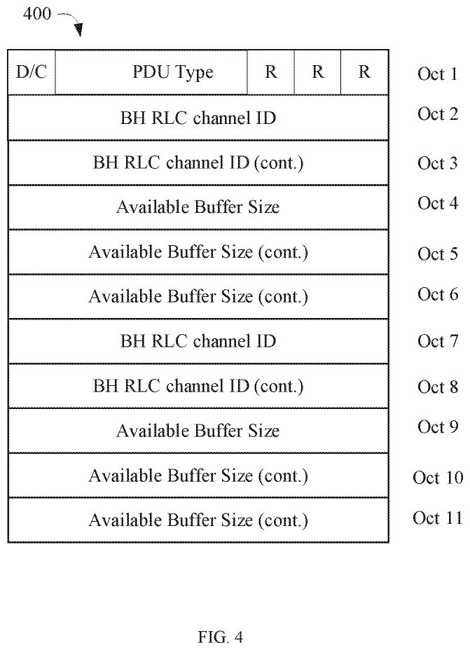

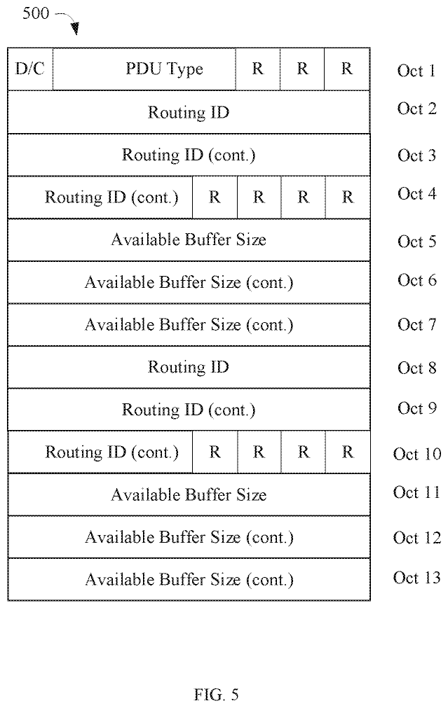

FIGS. 4 and 5 illustrate exemplary BAP PDU formats for flow control feedback in accordance with some embodiments of the present disclosure.

FIG. 4 illustrates an exemplary BAP PDU 400 format for flow control feedback per BH RLC channel in accordance with some embodiments of the present disclosure. As shown in FIG. 4, the BAP PDU 400 format can be octet aligned. The BAP PDU 400 can include 11 bytes, which can be respectively referred to as “Oct 1” to “Oct 11” in FIG. 4. Although the BAP PDU 400 shows two BH RLC channel IDs with corresponding available buffer sizes, it should be appreciated by persons skilled in the art that the BAP PDU 400 may indicate any number of BH RLC channel IDs with corresponding available buffer sizes.

The BAP PDU 400 format may include several fields such as a “D/C” field, “PDU Type” field, some “R” fields, some “BH RLC channel ID” fields, and some “Available Buffer Size” fields. In some examples, the “D/C” field may indicate whether the corresponding BAP PDU is a BAP data PDU or a BAP control PDU. The “PDU Type” field may indicate the type of control information included in the corresponding BAP control PDU. The “R” field may indicate a reserved bit(s). The “BH RLC channel ID” field may indicate the identity of the BH RLC channel whose flow control information is provided in the flow control feedback. The “Available Buffer Size” field may indicate the maximum traffic volume a transmitter should send.

It is contemplated that the BAP PDU 400 can have a format different from the format as illustrated in FIG. 4. For example, the fields shown in FIG. 4 may respectively include more or fewer bits in some other embodiments of the present disclosure. The BAP PDU 400 may include more or fewer fields in some other embodiments of the present disclosure.

FIG. 5 illustrates an exemplary BAP PDU 500 format for flow control feedback per BAP routing ID in accordance with some embodiments of the present disclosure. As shown in FIG. 5, the BAP PDU 500 format can be octet aligned. The BAP PDU 500 can include 13 bytes, which can be respectively referred to as “Oct 1” to “Oct 13” in FIG. 5. Although the BAP PDU 500 shows two routing IDs with corresponding available buffer sizes, it should be appreciated by persons skilled in the art that the BAP PDU 500 may indicate any number of routing IDs with corresponding available buffer sizes.

The BAP PDU 500 format may include several fields such as a “D/C” field, “PDU Type” field, some “R” fields, some “Routing ID” fields, and some “Available Buffer Size” fields. The “Routing ID” field may indicate the BAP routing identity, for which the flow control information is provided in the flow control feedback and may contain the BAP address and the BAP path identity. The “D/C” field, “PDU Type” field, “R” field, and “Available Buffer Size” field may have the same definitions as the corresponding fields described above with respect to FIG. 4.

It is contemplated that the BAP PDU 500 can have a format different from the format as illustrated in FIG. 5. For example, the fields shown in FIG. 5 may respectively include more or fewer bits in some other embodiments of the present disclosure. The BAP PDU 500 may include more or fewer fields in some other embodiments of the present disclosure.

An IAB node may indicate link conditions of the BH link between the IAB node and its parent node to its downstream IAB node(s). An IAB node may also indicate link conditions of the BH link between the IAB node and its child node to its upstream IAB node(s). Such indication may be a radio link failure (RLF) indication, which may indicate an RLF detection, a BH link recovery, a recovery success, or a recovery failure. For example, the RLF indication may be transmitted in response to the detection of an RLF in the BH link.

As stated above, the BAP layer may support routing, bearer mapping and flow control on a BH link. For BAP routing, UL or DL traffic on the BH link may be mapped to a BAP routing ID, which may be included in the BAP header. The BAP routing ID may include a BAP address which indicates the BAP address of a destination node in the BH link. The destination nodes of a DL BH link and a UL BH link may be an access IAB node and the DU of an IAB donor, respectively. The BAP routing ID may also include a path ID which indicates the routing path terminated at the destination node. A BH egress link on which the traffic is to be transmitted may be determined during the BAP routing procedure. For bearer mapping, the UL or DL traffic on the BH link may be mapped to an egress BH RLC channel (CH) of the determined egress link.

Embodiments of the present disclosure provide solutions to enhance the routing and bearer mapping of an IAB node, which can, for example, improve topology-wide fairness, multi-hop latency and congestion mitigation. More details on the embodiments of the present disclosure will be illustrated in the following text in combination with the appended drawings.

In some embodiments of the present disclosure, the BAP layer can reroute the UL or DL traffic locally (i.e., by itself) under certain conditions such as a BH RLF, follow control, etc. For example, in response to a failed buffer status reporting (BSR), flow control feedback, or an RLF indication, local rerouting may be triggered. An improved rerouting procedure may be performed.

In some embodiments of the present disclosure, the BAP layer can support local bearer remapping under certain conditions. For example, as will be described in detail below, in response to the flow control feedback, local bearer remapping may be triggered. An improved bearer mapping procedure may be performed.

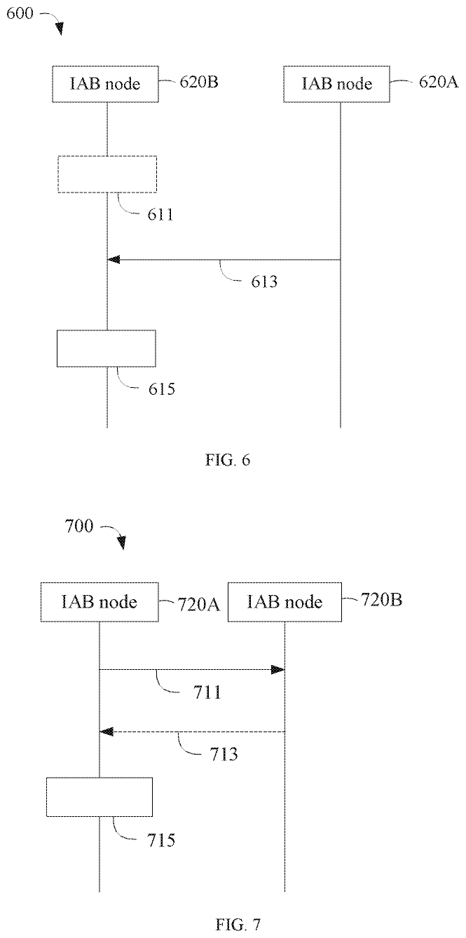

FIG. 6 illustrates a flow chart of an exemplary procedure 600 of wireless communications in accordance with some embodiments of the present disclosure. The procedure 600 shows an exemplary local bearer remapping procedure, which can be applied to either UL or DL transmissions.

Details described in all of the foregoing embodiments of the present disclosure are applicable for the embodiments shown in FIG. 6. It should be appreciated by persons skilled in the art that the sequence of the operations in exemplary procedure 600 may be changed and some of the operations in exemplary procedure 600 may be eliminated or modified, without departing from the spirit and scope of the disclosure.

Referring to FIG. 6, IAB node 620A may be a parent node or a child node of IAB node 620B. In some examples, IAB node 620A may function as IAB node 120A or IAB node 120D in FIG. 1, and IAB node 620B may function as IAB node 120B or IAB node 120C in FIG. 1.

In operation 613, IAB node 620A may transmit flow control feedback to IAB node 620B. The flow control feedback may include a BAP control PDU for flow control feedback. For example, the BAP control PDU may function as the BAP PDU 400 in FIG. 4. In operation 615, IAB node 620B may perform bearer remapping based on the received flow control feedback.

In some examples, in some embodiments of the present disclosure, IAB node 620B may select an available BH RLC CH based on the received flow control feedback. For example, IAB node 620B may determine an egress BH RLC CH as unavailable in response to the egress BH RLC CH being indicated in the received flow control feedback.

For instance, the flow control feedback may indicate at least one BH RLC CH. For example, referring back to FIG. 4, the BAP PDU 400 indicates two BH RLC CH IDs which correspond to two BH RLC CHs. Referring again to FIG. 6, IAB node 620B may determine that the BH RLC CH corresponding to the BH RLC CH ID indicated in the flow control feedback is unavailable and will not select such BH RLC CH as the egress BH RLC CH for data transmission.

IAB node 620B may be configured with a BH RLC CH mapping configuration. Each entry of the configuration may indicate an egress BH RLC CH ID. IAB node 620B may determine an entry of the configuration as unavailable in the case that the egress BH RLC CH ID of the entry is indicated in the flow control feedback. Each entry of the configuration may further indicate an ingress BH link, an ingress BH RLC CH and an egress BH link.

In some examples, IAB node 620B may determine an egress BH RLC CH as available in response to the egress BH RLC CH being not indicated in the received flow control feedback. In some examples, IAB node 620B may determine an egress BH RLC CH as available in response to the received flow control feedback indicating the egress BH RLC CH being available. In some examples, IAB node 620B may determine an egress BH RLC CH as unavailable in response to the received flow control feedback indicating the egress BH RLC CH being unavailable. As described above, IAB node 620B may similarly determine whether an entry of the BH RLC CH mapping configuration is available or unavailable.

In some embodiments of the present disclosure, IAB node 620B may select an available BH RLC CH based on the received flow control feedback and a threshold for available buffer size.

In some examples, in operation 611 (denoted by the dotted block as an option), IAB node 620B may be configured with a threshold for available buffer size by an IAB donor connected to IAB node 620B or the CU of the IAB donor (not shown in FIG. 6). In some other examples, the threshold for available buffer size may be predefined, for example, in a standard(s). The threshold for available buffer size may be configured or predefined per BH RLC CH or per IAB node. For example, IAB node 620B may be configured with corresponding thresholds for respective BH RLC CHs, which may be different or the same for different BH RLC CHs.

In some examples, IAB node 620B may determine an egress BH RLC CH as unavailable in response to the egress BH RLC CH being indicated in the received flow control feedback and an available buffer size of the egress BH RLC CH indicated in the received flow control feedback is less than or equal to the threshold for available buffer size. IAB node 620B may determine an entry of the BH RLC CH mapping configuration as unavailable in the case that an egress BH RLC CH ID of the entry is indicated in the flow control feedback and an available buffer size associated with the egress BH RLC CH ID indicated in the flow control feedback is less than or equal to the threshold for available buffer size.

In some examples, IAB node 620B may determine an egress BH RLC CH as available in response to the egress BH RLC CH being indicated in the received flow control feedback and an available buffer size of the egress BH RLC CH is greater than or equal to the threshold for available buffer size. IAB node 620B may similarly determine an entry of the BH RLC CH mapping configuration as available.

In some embodiments of the present disclosure, IAB node 620B may receive a BAP data PDU to be transmitted by IAB node 620B and may perform bearer remapping for the PDU based on the received flow control feedback.

For example, IAB node 620B may compare an ingress BH link, an ingress BH RLC channel CH and an egress BH link of the BAP data PDU to an entry of the BH RLC CH mapping configuration to determine a matched entry. The egress BH link of the BAP data PDU may be selected according to a BAP routing procedure. IAB node 620B may determine whether an egress BH RLC CH associated with the matched entry is available or not based on the received flow control feedback according to one of the methods as described above. For example, in the case that the egress BH RLC CH ID of the matched entry is indicated in the received flow control feedback, IAB node 620B may determine the egress BH RLC CH associated with the matched entry as unavailable.

In response to determining that the egress BH RLC CH associated with the matched entry is available, IAB node 620B may select the egress BH RLC CH associated with the matched entry for transmitting the BAP data PDU.

In response to determining that the egress BH RLC CH associated with the matched entry is unavailable, IAB node 620B may select an available egress BH RLC CH, a default BH RLC CH, or a backup BH RLC CH on the egress BH link of the BAP data PDU for transmitting the BAP data PDU. The available egress BH RLC CH(s) may be determined based on the received flow control feedback according to one of the methods as described above. In some example, when no available egress BH RLC CH is found, IAB node 620B may select the default or backup BH RLC CH. In some embodiments of the present disclosure, the default BH RLC CH, the backup BH RLC CH, or both may be configured by an IAB donor connected to IAB node 620B or a CU of the IAB donor. The default BH RLC CH may be configured per IAB node. The backup BH RLC CH may be configured per IAB node or per BH RLC CH.

In some examples, the above comparison procedure may be performed among the available entries of the BH RLC CH mapping configuration. The available entries may be determined based on the received flow control feedback according to one of the methods as described above.

For instance, IAB node 620B may compare an ingress BH link, an ingress BH RLC channel CH and an egress BH link of the BAP data PDU to an available entry of the BH RLC CH mapping configuration to find a matched entry. In the case that a matched entry is found, IAB node 620B may select the available egress BH RLC CH associated with the matched entry for transmitting the BAP data PDU. Otherwise, if no matched entry is found, IAB node 620B may select an available egress BH RLC CH, a default BH RLC CH, or a backup BH RLC CH on the egress BH link of the BAP data PDU for transmitting the BAP data PDU.

In some embodiments of the present disclosure, IAB node 620B may receive an indication, from an IAB donor connected to IAB node 620B or a parent IAB node of IAB node 620B, indicating whether bearer remapping based on flow control feedback is allowed or not at IAB node 620B. When the bearer remapping function based on flow control feedback is allowed, IAB node 620B may perform the bearer remapping procedure in response to the reception of the flow control feedback.

In some examples, the indication may indicate whether bearer remapping based on per BH RL CH flow control feedback is allowed or not. In some examples, the indication may be configured for both UL and DL transmissions. In some other examples, separate indications may be configured for UL and DL transmissions, respectively. In some examples, IAB node 620B may implicitly determine whether bearer remapping based on flow control feedback is allowed or not. For example, in response to receiving the threshold for available buffer size, IAB node 620B may determine that bearer remapping based on flow control feedback is allowed. In some examples, the local bearer remapping function triggered by the flow control feedback is allowed at an IAB node by default.

In some embodiments of the present disclosure, IAB node 620B may report, to the IAB donor connected to IAB node 620B or a parent IAB node of IAB node 620B, a capability of whether bearer remapping based on flow control feedback is supported or not at IAB node 620B. In some examples, IAB node 620B may report such capability of bearer remapping for UL and DL transmissions separately or jointly. In some examples, the IAB donor or the parent IAB node may transmit the above indication for allowing or forbidding the bearer remapping function triggered by the flow control feedback based on the received capability.

In the above embodiments, a local bearer remapping, instead of local rerouting, is triggered in response to the flow control feedback. This is beneficial because although some BH RLC CHs of an egress BH link may be congested, other BH RLC CHs of the egress BH link may be still available for data transport.

FIG. 7 illustrates a flow chart of an exemplary procedure 700 of wireless communications in accordance with some embodiments of the present disclosure. The procedure 700 shows an exemplary local rerouting procedure.

Details described in all of the foregoing embodiments of the present disclosure are applicable for the embodiments shown in FIG. 7. It should be appreciated by persons skilled in the art that the sequence of the operations in exemplary procedure 700 may be changed and some of the operations in exemplary procedure 700 may be eliminated or modified, without departing from the spirit and scope of the disclosure.

Referring to FIG. 7, IAB node 720B may be a parent node of IAB node 720A. In some examples, IAB node 720A and IAB node 720B may function as IAB node 120A and IAB node 120B in FIG. 1, respectively.

In operation 711, IAB node 720A may transmit or trigger a buffer status reporting (BSR) to IAB node 720B for UL grant. The BSR may be a BSR providing the UL data volume in the MAC entity of IAB node 720A or a pre-emptive BSR providing the amount of the data expected to arrive at IAB node 720A.

In some embodiments of the present disclosure, in operation 713 (denoted by the dotted arrow as an option), IAB node 720B may transmit a BSR failure indication to IAB node 720A in response to the BSR. In some examples, the BSR failure indication may be a negative acknowledgement (NACK) of a MAC PDU including the BSR. In some examples, the BSR failure indication may be explicitly indicated by a MAC control element (CE).

In some embodiments of the present disclosure, IAB node 720A may start a timer in response to the transmission or triggering of the BSR. The value of the timer may be configured by an IAB donor connected to IAB node 720A, the CU of the IAB donor (not shown in FIG. 7), or a parent node of IAB node 720A. In some other examples, the value of the timer may be predefined, for example, in a standard(s).

In operation 715, IAB node 720A may determine a BSR failure associated with IAB node 720B. In some examples, IAB node 720A may determine the failure of the BSR in response to the expiry of the timer. In some examples, IAB node 720A may determine the failure of the BSR in response to the reception of the BSR failure indication.

IAB node 720A may perform rerouting based on the failure of the BSR. For example, IAB node 720A may determine an egress BH link between IAB node 720A and IAB node 720B as unavailable in response to the failure of the BSR. IAB node 720A may select an available egress BH link for data transmission.

In some embodiments of the present disclosure, IAB node 720A may receive a BAP data PDU to be transmitted by IAB node 720A, and may perform rerouting for the PDU based on the failure of the BSR. For example, IAB node 720A may be configured with a BH routing configuration. Each entry of the configuration may indicate a BAP routing ID and an egress link.

IAB node 720A may compare the BAP routing ID of the BAP data PDU to an entry of the BH routing configuration to determine a matched entry. For instance, when a BAP address of an entry matches the destination field in the BAP data PDU and the BAP path identity of the entry matches the path field in the BAP data PDU, the entry can be determined as a matched entry.

In response to an egress BH link associated with the matched entry being available, IAB node 720A may select the available egress BH link associated with the matched entry for transmitting the BAP data PDU. IAB node 720A may determine whether an egress BH link associated with the matched entry is available or not based on the failure of the BSR according to the method as described above.

In response to the egress BH link associated with the matched entry being unavailable or no matched entry is found (hereinafter, “failed routing ID match”), IAB node 720A may select an available egress BH link associated with an entry of the BH routing configuration based on the failure of the BSR and may transmit the BAP data PDU on the selected available egress BH link.

For instance, in some cases, in response to the failed routing ID match, IAB node 720A may compare the destination field in the BAP data PDU to an entry of the BH routing configuration to determine a matched entry (hereinafter, “destination match step”). When a BAP address of an entry matches the destination field in the BAP data PDU, the entry can be determined as a matched entry. In response to an egress BH link associated with the matched entry being available, IAB node 720A may select the available egress BH link associated with the matched entry for transmitting the BAP data PDU. In response to more than one matched entry is found, IAB node 720A may select one of the available egress BH links associated with the more than one matched entry for transmitting the BAP data PDU. In response to the egress BH link associated with the matched entry being unavailable or no match is found, IAB node 720A may determine whether any entry of the BH routing configuration indicates an available egress BH link (such an entry is also referred to as “available entry”). IAB node 720A may select the egress BH link associated with an available entry for transmitting the BAP data PDU.

In some other cases, IAB node 720A may not perform the destination match step, and may determine whether there is an available entry in the BH routing configuration in response to the failed routing ID match. IAB node 720A may select the egress BH link associated with the available entry for transmitting the BAP data PDU.

In some examples, the above comparison procedure may be performed among the available entries of the BH routing configuration. The available entries may be determined based on the failure of the BSR as described above.

In some embodiments of the present disclosure, IAB node 720A may receive an indication, from an IAB donor connected to IAB node 720A or a parent IAB node (e.g., IAB node 720B) of IAB node 720A, indicating whether rerouting based on the failure of a BSR is allowed or not at IAB node 720A. In some examples, the rerouting function based on the BSR failure is allowed at an IAB node by default. When the rerouting function based on the BSR failure is allowed, IAB node 720A may perform the rerouting procedure in response to a BSR failure.

In some embodiments of the present disclosure, IAB node 720A may report, to the IAB donor connected to IAB node 720A or a parent IAB node (e.g., IAB node 720B) of IAB node 720A, a capability of whether rerouting based on the failure of a BSR is supported or not at IAB node 720A. In some examples, the IAB donor or the parent IAB node may transmit the above indication for allowing or forbidding the rerouting function based on the BSR failure based on the received capability.

In the above embodiments, a BSR failure can trigger local rerouting. This is beneficial because a BSR failure may indicate congestion in the corresponding UL link and triggering a local rerouting in response to the BSR failure can avoid data congestion.

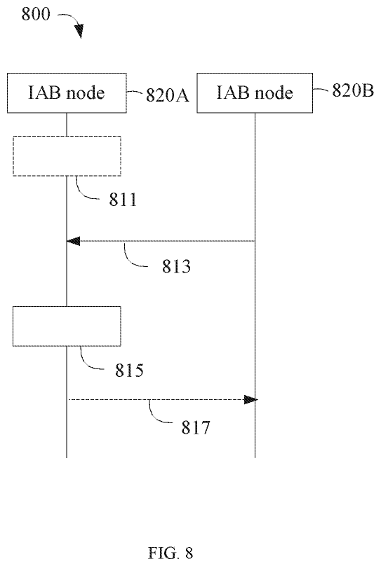

FIG. 8 illustrates a flow chart of an exemplary procedure 800 of wireless communications in accordance with some embodiments of the present disclosure. The procedure 800 shows an exemplary local rerouting procedure, which can be applied to either UL or DL transmissions. Details described in all of the foregoing embodiments of the present disclosure are applicable for the embodiments shown in FIG. 8.

Referring to FIG. 8, IAB node 820B may be a parent or child node of IAB node 820A. In some examples, IAB node 820A may function as IAB node 120A or IAB node 120D in FIG. 1, and IAB node 820B may function as IAB node 120B or IAB node 120C in FIG. 1.

In operation 813, IAB node 820B may transmit flow control feedback to IAB node 820A. The flow control feedback may include a BAP control PDU for flow control feedback. For example, the BAP control PDU may function as the BAP PDU 500 in FIG. 5.

In operation 815, IAB node 820A may perform local rerouting based on the received flow control feedback.

In some examples, in some embodiments of the present disclosure, IAB node 820A may select an available egress BH link based on the received flow control feedback. For example, the received flow control feedback may indicate a BAP routing ID(s). IAB node 820A may determine an egress BH link associated with the BAP routing ID as unavailable and will not select this egress BH link for data transmission.

For instance, IAB node 820A may be configured with a BH routing configuration. Each entry of the configuration may indicate a BAP routing ID and an egress link. When the BAP routing ID of an entry is indicated in the received flow control feedback, IAB node 820A may determine the entry and the egress link of the entry as unavailable.

In some examples, IAB node 820A may determine an egress BH link as available in response to a BAP routing ID with which the egress BH link is associated being not indicated in the received flow control feedback. In some examples, IAB node 820A may determine an egress BH link as available in response to the received flow control feedback indicating a BAP routing ID with which the egress BH link is associated being available. In some examples, IAB node 820A may determine an egress BH link as unavailable in response to the received flow control feedback indicating a BAP routing ID with which the egress BH link is associated being unavailable. IAB node 820A may similarly determine whether an entry of the BH routing configuration is available or unavailable.

In some embodiments of the present disclosure, IAB node 820A may select an available BH link based on the received flow control feedback and a threshold for available buffer size.

In some examples, in operation 811 (denoted by the dotted block as an option), IAB node 820A may be configured with a threshold for available buffer size by an IAB donor connected to IAB node 820A or the CU of the IAB donor (not shown in FIG. 8). In some other examples, the threshold for available buffer size may be predefined, for example, in a standard(s). The threshold for available buffer size may be configured or predefined per BAP routing ID or per IAB node. For example, IAB node 820A may be configured with corresponding thresholds for respective BAP routing IDs, which may be different or the same for different BAP routing IDs.

In some examples, IAB node 820A may determine an egress BH link as unavailable in response to the BAP routing ID with which the egress BH link is associated being indicated in the received flow control feedback and an available buffer size associated with the BAP routing ID indicated by the received flow control feedback is less than or equal to the threshold for available buffer size. IAB node 820A may determine an entry of the BH routing configuration as unavailable in the case that the BAP routing ID of the entry is indicated in the flow control feedback and an available buffer size associated with the BAP routing ID indicated in the flow control feedback is less than or equal to the threshold for available buffer size.

In some examples, IAB node 820A may determine an egress BH link as available in response to the BAP routing ID with which the egress BH link is associated being indicated in the received flow control feedback and an available buffer size associated with the BAP routing ID is greater than or equal to the threshold for available buffer size. IAB node 820A may similarly determine an entry of the BH routing configuration as available.

In some embodiments of the present disclosure, IAB node 820A may receive a BAP data PDU to be transmitted by IAB node 820A and may perform rerouting for the PDU based on the received flow control feedback.

For example, IAB node 820A may determine at least one available entry of the BH routing configuration based on the received flow control feedback according to one of the methods as described above. In response to a match between a BAP routing ID of the BAP data PDU and an entry of the at least one available entry, IAB node 820A may select an available egress BH link associated with the matched entry. For instance, when a BAP address of an available entry (hereinafter, “first available entry”) of the at least one available entry matches the destination field in the BAP data PDU and the BAP path identity of the first available entry matches the path field in the BAP data PDU, the first available entry can be determined as a matched entry. IAB node 820A may then select the available egress BH link associated with the first available entry (as indicated in the BH routing configuration) for transmitting the BAP data PDU.

In response to no match between the BAP routing ID of the BAP data PDU and the at least one the available entry (hereinafter, “failed routing ID match”), IAB node 820A may select an available egress BH link associated with an available entry (hereinafter, “second available entry”) of the at least one available entry, and may transmit the BAP data PDU on the selected available egress BH link. The second available entry may be the same as or different from the first available entry.

For instance, in some cases, in response to the failed routing ID match, IAB node 820A may compare the destination field in the BAP data PDU to an available entry of the at least one available entry to determine a matched entry (hereinafter, “destination match step”). For example, when a BAP address of an available entry of the at least one available entry matches the destination field in the BAP data PDU, this available entry can be determined as a matched entry. In response to an egress BH link associated with such available entry being available, IAB node 820A may select the available egress BH link associated with this available entry (e.g., the second available entry) for transmitting the BAP data PDU. In response to more than one matched entry is found, IAB node 820A may select one of the available egress BH links associated with the more than one matched entry for transmitting the BAP data PDU.

Otherwise, in response to the egress BH link being unavailable or no match is found, IAB node 820A may determine whether there is any entry of the at least one available entry that indicates an available egress BH link. IAB node 820A may select the available egress BH link associated with this available entry (e.g., the second available entry) for transmitting the BAP data PDU.

In some other cases, IAB node 820A may not perform the destination match step, and may determine whether there is an available entry of the at least one available entry with an available egress BH link in response to the failed routing ID match. IAB node 820A may select the available egress BH link associated with such available entry for transmitting the BAP data PDU.

In some embodiments of the present disclosure, IAB node 820A may receive an indication, from an IAB donor connected to IAB node 820A or a parent IAB node of IAB node 820A, indicating whether rerouting based on flow control feedback is allowed or not at IAB node 820A. When the rerouting function based on flow control feedback is allowed, IAB node 820A may perform the rerouting procedure in response to the reception of the flow control feedback.

In some examples, the indication may indicate whether rerouting based on per BAP routing ID flow control feedback is allowed or not. In some examples, the indication may be configured for both UL and DL transmissions. In some other examples, separate indications may be configured for UL and DL transmissions, respectively. In some examples, IAB node 820A may implicitly determine whether rerouting based on flow control feedback is allowed or not. For example, in response to receiving the threshold for available buffer size, IAB node 820A may determine that rerouting based on flow control feedback is allowed. In some examples, the local rerouting function triggered by the flow control feedback is allowed at an IAB node by default.

In some embodiments of the present disclosure, IAB node 820A may report, to the IAB donor connected to IAB node 820A or a parent IAB node of IAB node 820A, a capability of whether rerouting based on flow control feedback is supported or not at IAB node 820A. In some examples, IAB node 820A may report such capability of rerouting for UL and DL transmissions separately or jointly. In some examples, the IAB donor or the parent IAB node may transmit the above indication for allowing or forbidding the rerouting function based on flow control feedback based on the received capability.

In operation 817 (denoted by the dotted arrow as an option), IAB node 820A may transmit an acknowledgement to IAB node 820B in response to the local rerouting based on the flow control feedback. The acknowledgement may facilitate IAB node management for load balance.

It should be appreciated by persons skilled in the art that the sequence of the operations in exemplary procedure 800 may be changed and some of the operations in exemplary procedure 800 may be eliminated or modified, without departing from the spirit and scope of the disclosure.

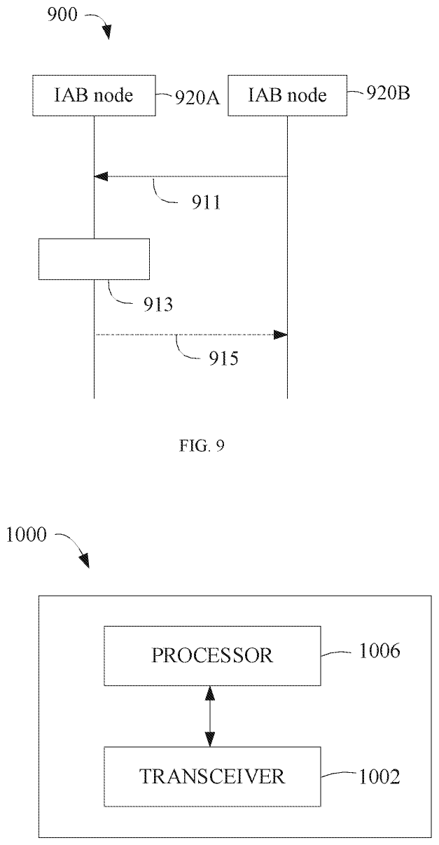

FIG. 9 illustrates a flow chart of an exemplary procedure 900 of wireless communications in accordance with some embodiments of the present disclosure. The procedure 900 shows an exemplary local rerouting procedure, which can be applied to either UL or DL transmissions. Details described in all of the foregoing embodiments of the present disclosure are applicable for the embodiments shown in FIG. 9.

Referring to FIG. 9, IAB node 920B may be a parent or child node of IAB node 920A. In some examples, IAB node 920A may function as IAB node 120A or

IAB node 120D in FIG. 1, and IAB node 920B may function as IAB node 120B or IAB node 120C in FIG. 1.

In operation 911. IAB node 920B may transmit an RLF indication to IAB node 920A. The RLF indication may indicate an RLF detection, a BH link recovery, a recovery success, or a recovery failure.

In operation 913, IAB node 920A may perform local rerouting based on the received RLF indication.

In some examples, the RLF indication may indicate an RLF detection or a BH link recovery, or a recovery failure. IAB node 920A may determine an egress BH link between IAB node 920A and IAB node 920B as unavailable and may select an available egress BH link of IAB node 920A for data transmission.

For instance, IAB node 920B may be a parent of IAB node 920A. In response to IAB node 920B detecting that a BH link between IAB node 920B and a parent node of IAB node 920B (also referred to as “grandparent node of IAB node 920A”) suffers an RLF or a recovery failure or triggers a BH link recovery, IAB node 920B may transmit the RLF indication to IAB node 920A. IAB node 920A may perform UL local rerouting in response to the RLF indication. For example, IAB node 920A may determine that the egress link between IAB node 920A and IAB node 920B is unavailable, and may select an available egress BH link for UL transmission.

For instance, IAB node 920B may be a child of IAB node 920A. In response to IAB node 920B detecting that the BH link between IAB node 920B and a child node of IAB node 920B (also referred to as “grandchild node of IAB node 920A”) suffers an RLF or a recovery failure or triggers a BH link recovery, IAB node 920B may transmit the RLF indication to IAB node 920A. IAB node 920A may perform DL local rerouting in response to the RLF indication. For example, IAB node 920A may determine that the egress link between IAB node 920A and IAB node 920B is unavailable, and may select an available egress BH link for DL transmission.

In some examples, the RLF indication may indicate a recovery success. IAB node 920A may determine an egress BH link between IAB node 920A and IAB node 920B as available and may select an available egress BH link of IAB node 920A for data transmission.

For instance, IAB node 920B may be a parent of IAB node 920A. In response to IAB node 920B detecting that the BH link between IAB node 920B and a parent node of IAB node 920B is successfully recovered from an RLF, IAB node 920B may transmit the RLF indication to IAB node 920A. IAB node 920A may determine that the egress link between IAB node 920A and IAB node 920B has become available again, and may select the egress link (or another available egress link) for UL transmission.

For instance, IAB node 920B may be a child of IAB node 920A. In response to IAB node 920B detecting that the BH link between IAB node 920B and a child node of IAB node 920B is successfully recovered from an RLF, IAB node 920B may transmit the RLF indication to IAB node 920A. IAB node 920A may determine that the egress link between IAB node 920A and IAB node 920B has become available again, and may select the egress link (or another available egress link) for DL transmission.

In some examples, IAB node 920A may determine an entry of the BH routing configuration as unavailable (or available) when the egress link associated with the entry is unavailable (or available).

In some embodiments of the present disclosure, IAB node 920A may receive a BAP data PDU to be transmitted by IAB node 920A and may perform rerouting for the PDU based on the received RLF indication. For example, IAB node 920A may compare the BAP routing ID of the BAP data PDU to an entry of the BH routing configuration to determine a matched entry. For instance, when a BAP address of an entry matches the destination field in the BAP data PDU and the BAP path identity of the entry matches the path field in the BAP data PDU, the entry can be determined as a matched entry.

In response to an egress BH link associated with the matched entry being available, IAB node 920A may select the available egress BH link associated with the matched entry for transmitting the BAP data PDU. IAB node 920A may determine whether an egress BH link associated with the matched entry is available or not based on the received RLF indication according to the method as described above.

In response to the egress BH link associated with the matched entry being unavailable or no matched entry is found (hereinafter, “failed routing ID match”), IAB node 920A may select an available egress BH link associated with an entry of the BH routing configuration based on the received RLF indication and may transmit the BAP data PDU on the selected available egress BH link.

For instance, in some cases, in response to the failed routing ID match, IAB node 920A may compare the destination field in the BAP data PDU to an entry of the BH routing configuration to determine a matched entry (hereinafter, “destination match step”). When a BAP address of an entry matches the destination field in the BAP data PDU, the entry can be determined as a matched entry. In response to an egress BH link associated with the matched entry being available, IAB node 920A may select the available egress BH link associated with the matched entry for transmitting the BAP data PDU. In response to more than one matched entry is found, IAB node 920A may select one of the available egress BH links associated with the more than one matched entry for transmitting the BAP data PDU. In response to the egress BH link associated with the matched entry being unavailable or no match is found, IAB node 920A may determine whether any entry of the BH routing configuration indicates an available egress BH link (i.e., an available entry). IAB node 920A may select the egress BH link associated with the available entry for transmitting the BAP data PDU.

In some other cases, IAB node 920A may not perform the destination match step, and may determine whether there is an available entry in the BH routing configuration in response to the failed routing ID match. IAB node 920A may select the egress BH link associated with the available entry for transmitting the BAP data PDU.

In some examples, the above comparison procedure may be performed among the available entries of the BH routing configuration. The available entries may be determined based on the received RLF indication as described above.

In some embodiments of the present disclosure, IAB node 920A may receive an indication, from an IAB donor connected to IAB node 920A or a parent IAB node of IAB node 920A, indicating whether rerouting based on an RLF indication is allowed or not at IAB node 920A. The RLF indication may indicate an RLF detection, a BH link recovery, a recovery success, or a recovery failure. When the rerouting function based on an RLF indication is allowed, IAB node 920A may perform the rerouting procedure in response to the reception of an RLF indication.

In some examples, the indication may be configured for both UL and DL transmissions. In some other examples, separate indications may be configured for UL and DL transmissions, respectively. In some examples, the local rerouting function triggered by the RLF indication is allowed at an IAB node by default.

In some embodiments of the present disclosure, IAB node 920A may report, to the IAB donor connected to IAB node 920A or a parent IAB node of IAB node 920A, a capability of whether an RLF indication is supported or not at IAB node 920A, or a capability of whether rerouting based on an RLF indication is supported or not at IAB node 920A, or both. In some examples, IAB node 920A may report the above capability for UL and DL transmissions separately or jointly. In some examples, the IAB donor or the parent IAB node may transmit the above indication for allowing or forbidding the rerouting function based on the RLF indication based on the received capability.

In operation 915 (denoted by the dotted arrow as an option), IAB node 920A may transmit an acknowledgement to IAB node 920B in response to the local rerouting based on the received RLF indication. The acknowledgement may facilitate IAB node management for load balance.

It should be appreciated by persons skilled in the art that the sequence of the operations in exemplary procedure 900 may be changed and some of the operations in exemplary procedure 900 may be eliminated or modified, without departing from the spirit and scope of the disclosure.

FIG. 10 illustrates a block diagram of an exemplary apparatus 1000 according to some embodiments of the present disclosure.

As shown in FIG. 10, the apparatus 1000 may include at least one processor 1006 and at least one transceiver 1002 coupled to the processor 1006. The apparatus 1000 may be an IAB donor or an IAB node.

Although in this figure, elements such as the at least one transceiver 1002 and processor 1006 are described in the singular, the plural is contemplated unless a limitation to the singular is explicitly stated. In some embodiments of the present application, the transceiver 1002 may be divided into two devices, such as a receiving circuitry and a transmitting circuitry. In some embodiments of the present application, the apparatus 1000 may further include an input device, a memory, and/or other components.

In some embodiments of the present application, the apparatus 1000 may be an IAB node. The transceiver 1002 and the processor 1006 may interact with each other so as to perform the operations with respect to the IAB nodes described in FIGS. 1-9. For example, the transceiver 1002 transceiver may be configured to receive flow control feedback. The processor 1006 may be configured to perform bearer remapping based on the received flow control feedback.

In some embodiments of the present application, the apparatus 1000 may be an IAB donor. The transceiver 1002 and the processor 1006 may interact with each other so as to perform the operations with respect to the IAB donors described in FIGS. 1-9.

In some embodiments of the present application, the apparatus 1000 may further include at least one non-transitory computer-readable medium.

For example, in some embodiments of the present disclosure, the non-transitory computer-readable medium may have stored thereon computer-executable instructions to cause the processor 1006 to implement the method with respect to the IAB nodes as described above. For example, the computer-executable instructions, when executed, cause the processor 1006 interacting with transceiver 1002, so as to perform the operations with respect to the IAB nodes described in FIGS. 1-9.

In some embodiments of the present disclosure, the non-transitory computer-readable medium may have stored thereon computer-executable instructions to cause the processor 1006 to implement the method with respect to the IAB donors as described above. For example, the computer-executable instructions, when executed, cause the processor 1006 interacting with transceiver 1002, so as to perform the operations with respect to the IAB donors described in FIGS. 1-9.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including.” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

What is claimed is:

1. An integrated access and backhaul (IAB) node for wireless communication, comprising:
at least one memory; and
at least one processor coupled with the at least one memory and configured to cause the IAB node to:
receiving flow control feedback; and
performing bearer remapping based on the received flow control feedback.

2. The LAB node of claim 1, wherein to perform bearer remapping based on the received flow control feedback, the at least one processor is configured to cause the IAB node to:
selecting select an available egress backhaul (BH) radio link control (RLC) channel (CH) based on the received flow control feedback.

3. The IAB node of claim 2, wherein the at least one processor is configured to cause the IAB node to:
determine an egress BH RLC CH as unavailable in response to the egress BH RLC CH being indicated in the received flow control feedback.

4. The LAB node method claim 1, wherein to perform bearer remapping based on the received flow control feedback, the at least one processor is configured to cause the IAB node to:
selecting select an available egress backhaul (BH) radio link control (RLC) channel (CH) based on the received flow control feedback and a threshold for available buffer size.

4. LAB node of claim 4, wherein the at least one processor is configured to cause the IAB node to at least one of:
determine an egress BH RLC CH as unavailable in response to the egress BH RLC CH being indicated in the received flow control feedback and an available buffer size of the egress BH RLC CH is less than or equal to the threshold for available buffer size; or
determine an egress BH RLC CH as available in response to the egress BH RLC CH being indicated in the received flow control feedback and an available buffer size of the egress BH RLC CH is greater than the threshold for available buffer size.

6. The LAB node of claim 1, wherein the at least one processor is configured to cause the IAB node to:
receive an indication, from an IAB donor connected to the IAB node or a parent IAB node of the IAB node, indicating whether bearer remapping based on flow control feedback is allowed or not at the IAB node.

7. The LAB node of claim 1, wherein the at least one processor is configured to cause the IAB node to:
transmit, to an IAB donor connected to the IAB node or a parent IAB node of the IAB node, a capability of whether bearer remapping based on flow control feedback is supported or not at the IAB node.

8. An integrated access and backhaul (IAB) node for wireless communication, comprising:
at least one memory; and
at least one processor coupled with the at least one memory and configured to cause the IAB node to:
determine a failure of a buffer status reporting (BSR) associated with a parent node of the IAB node; and
performing rerouting based on the failure of the BSR, in order to reroute data from the parent node of the IAB node.

9. The IAB node of claim 8, wherein to perform the rerouting based on the failure of the BSR, the at least one processor is configured to cause the IAB node to:
determine an egress backhaul (BH) link between the IAB node and the parent node of the IAB node as unavailable; and
select an available egress BH link of the IAB node for data transmission.

10. The LAB node of claim 8, wherein the at least one processor is configured to cause the IAB node to:
perform one or more of transmit or trigger the BSR to the parent node of the IAB node; and
receive a BSR failure indication from the parent node of the IAB node in response to the BSR;
wherein to determine the failure of the BSR, the at least one processor is configured to cause the IAB node to determine the failure of the BSR in response to the reception of the BSR failure indication.

11. The IAB node of claim 8, wherein the at least one processor is configured to cause the IAB node to:
perform one or more of transmit or trigger the BSR to the parent node of the IAB node; and
start a timer in response to transmission or triggering of the BSR;
wherein to determine the failure of the BSR, the at least one processor is configured to cause the IAB node to determine the failure of the BSR in response to expiry of the timer.

12. The IAB node of claim 8, wherein the at least one processor is configured to cause the IAB node to:
receive an indication, from one or more of an IAB donor connected to the IAB node or the parent IAB node of the IAB node, indicating whether rerouting based on a failure of a BSR is allowed or not at the IAB node.

13. The IAB node method of claim 8, wherein the at least one processor is configured to cause the IAB node to:
transmit, to one or more of an IAB donor connected to the IAB node or the parent IAB node of the IAB node, a capability of whether rerouting based on a failure of a BSR is supported or not at the IAB node.

14. (canceled)

15. (canceled)

16. A method performed by an integrated access and backhaul (IAB) node, comprising:
receiving flow control feedback; and
perform bearer remapping based on the received flow control feedback.

17. The method of claim 16, wherein performing bearer remapping based on the received flow control feedback comprises selecting an available egress backhaul (BH) radio link control (RLC) channel (CH) based on the received flow control feedback.

18. The method of claim 17, further comprising determining an egress BH RLC CH as unavailable in response to the egress BH RLC CH being indicated in the received flow control feedback.

19. The method of claim 16, wherein performing bearer remapping based on the received flow control feedback comprises selecting an available egress backhaul (BH) radio link control (RLC) channel (CH) based on the received flow control feedback and a threshold for available buffer size.

20. A method performed by an integrated access and backhaul (IAB) node, comprising:
determining a failure of a buffer status reporting (BSR) associated with a parent node of the IAB node; and
performing rerouting based on the failure of the BSR, in order to reroute data from the parent node of the IAB node.

21. The method of claim 20, wherein performing the rerouting based on the failure of the BSR comprises:
determining an egress backhaul (BH) link between the IAB node and the parent node of the IAB node as unavailable; and
selecting an available egress BH link of the IAB node for data transmission.

22. The method of claim 20, further comprising:
performing one or more of transmitting or triggering the BSR to the parent node of the IAB node; and
receiving a BSR failure indication from the parent node of the IAB node in response to the BSR;
wherein determining the failure of the BSR comprises determining the failure of the BSR in response to reception of the BSR failure indication.
